(19) United States
(12) Patent Application Publication
(10) Pub. No.: US 2004/0088329 A1
(43) Pub. Date: May 6, 2004

(54) Methods and system for collecting, tracking, and analyzing safety and health related information

(75) Inventors: Franklin P. Lundblad, Bethesda, MD (US); Samuel M. Pulcrano, Annadale, VA (US)

Correspondence Address: Finnegan, Henderson, Farabow,, Garrett & Dunner, L.L.P., 1300 I Street, N.W., Washington, DC, 20005-3315, US

(73) Assignee: United States Postal Service.

(21) Appl. No.: 10/641,112

(22) Filed: Aug. 15, 2003

Related U.S. Application Data
(60) Provisional application No. 60/422,713, filed on Oct. 31, 2002.

(51) Int. Cl. G06F 17/30

(52) U.S. Cl. 707/104.1

(57) ABSTRACT

Methods and systems consistent with the present invention provide for performing a facility inspection. A mobile data collection device or client receives scheduling information corresponding to an inspection to be performed at a facility. The mobile data collection device or client collects inspection data corresponding to the inspection to be performed at the facility and causes the inspection data to be stored in a database. Thereafter, the mobile data collection device or client may modify the stored inspection data using a web interface. Scheduling information is updated based on the stored inspection data.

### RELATED APPLICATIONS

This application claims the benefit of U.S. Provisional Patent Application No. 60/422,713, entitled “Safety Toolkit,” which was filed on Oct. 31, 2002, the disclosure of which is hereby expressly incorporated herein by reference.

### TECHNICAL FIELD

The present invention relates generally to data processing systems and, more particularly, to methods and systems for collecting, tracking, and analyzing safety and health-related information.

### BACKGROUND

Many corporations and institutions in their operations have a safety inspection program to consistently monitor unsafe conditions and to record it. The monitoring is done to safeguard employees' safety and health and to comply with regulations set by Occupational Health and Safety Administration (OSHA).

For example, the United States Postal Service (USPS) has approximately 30,000 facilities that are monitored to meet safety standards. A check list is established and a safety inspector visits each facility annually or biannually to inspect the conditions and verify them according to the check list. This information taken from the field is then entered manually into the computer database.

Entering information in this manner, however, is time consuming, manual, and lags behind in times as the entry is made sometime after the inspection in the field. Additionally, safety personnel conduct periodic safety and health program evaluations to measure the overall effectiveness of facility level safety and health programs. This information must be collected and a program score recorded.

### SUMMARY

Methods and systems consistent with the present invention provide for performing a facility inspection. A mobile data collection device or client receives scheduling information corresponding to an inspection to be performed at a facility. The mobile data collection device or client collects inspection data corresponding to the inspection to be performed at the facility and causes the inspection data to be stored in a database. Thereafter, the mobile data collection device or client may modify the stored inspection data using a web interface. Scheduling information is updated based on the stored inspection data.

Other methods and systems consistent with the present invention provide for performing a facility program evaluation. A mobile data collection device or client receives scheduling information corresponding to a program evaluation to be performed at a facility, the program evaluation being for use in rating safety and health guidelines at the facility. The mobile data collection device or client collects program evaluation data corresponding to the program evaluation to be performed at the facility. Thereafter, a score associated with the program evaluation is calculated, the program evaluation data and calculated score is stored in a database, and the scheduling information is updated based on the stored program evaluation data and calculated

Other methods and systems consistent with the present invention also provide for performing a facility inspection. A client sends, to at least one mobile data collection device, scheduling information corresponding to an inspection to be performed at a facility. The client also transmits, to each mobile collection device, periodic reminders of the inspection to be performed at the facility, wherein each mobile collection device collects inspection data corresponding to the inspection to be performed at the facility and stores the inspection data in a remote database. Thereafter, the client receives updated scheduling information based on the stored inspection data.

Other methods and systems consistent with the present invention also provide for performing a facility program evaluation. A client sends, to at least one mobile data collection device, scheduling information corresponding to an program evaluation to be performed at a facility, the program evaluation being for use in rating safety and health guidelines at the facility. The client also transmits, to each mobile collection device, periodic reminders of the program evaluation to be performed at the facility, wherein each mobile collection device collects program evaluation data corresponding to the program evaluation to be performed at the facility and stores the program evaluation data in a remote database. Thereafter, the client receives updated scheduling information based on the stored program evaluation data.

### BRIEF DESCRIPTION OF THE DRAWINGS

The accompanying drawings, which are incorporated in and constitute a part of this specification, illustrate one embodiment of the invention and, together with the description, serve to explain the principles of the invention.

FIG. 1 is a diagram of an exemplary network environment in which features and aspects consistent with the principals of the present invention may be implemented;

FIG. 2 is a diagram of another exemplary network environment in which features and aspects consistent with the principals of the present invention may be implemented;

FIG. 3 is a diagram of an exemplary data center, consistent with the principals of the present invention;

FIG. 4 is a diagram of an exemplary data collection device, consistent with the principals of the present invention;

FIG. 5A is a diagram of an exemplary web server, consistent with the principals of the present invention;

FIG. 5B is a diagram of an exemplary database server, consistent with the principals of the present invention;

FIG. 6 is a diagram of a client, consistent with the principals of the present invention;

FIG. 7 is a diagram of an exemplary flowchart of a method for inspection and PEG scheduling for large facilities consistent with the present invention;

FIG. 8 is a diagram of an exemplary flowchart of a method for inspection and SFPEG scheduling for small facilities consistent with the present invention;

FIG. 9 is a diagram of an exemplary flowchart of a method for inspection data collection for a single inspector consistent with the present invention;

FIG. 10 is a diagram of an exemplary flowchart of a method for inspection data collection for multiple inspectors consistent with the present invention;

FIG. 11 is a diagram of an exemplary flowchart of a method for PEG or SFPEG data collection consistent with the present invention; and

FIG. 12 is a diagram of an exemplary flowchart of a method for hazard log data collection consistent with the present invention.

### DETAILED DESCRIPTION

Reference will now be made in detail to exemplary embodiments of the present invention, examples of which are illustrated in the accompanying drawings. Wherever possible, the same reference numbers will be used throughout the drawings to refer to the same or like parts. While the description includes exemplary embodiments, other embodiments are possible, and changes may be made to the embodiments described without departing from the spirit and scope of the invention. The following detailed description does not limit the invention. Instead, the scope of the invention is defined by the appended claims and their equivalents.

### Overview

Methods and systems consistent with the present invention provide for managing facility inspections or facility program evaluations. A plurality of mobile data collection devices are operable to receive scheduling information corresponding to a inspection or program evaluation to be performed at a facility and collect inspection data or program evaluation data corresponding to the inspection or program evaluation to be performed at the facility. The mobile data collection devices may also calculate a score associated with the program evaluation, send the program evaluation data to a data center for storage in a database, and update the scheduling information based on the stored program evaluation data and calculated score.

Additionally, the mobile data collection devices may send the inspection data to the data center for storage in the database, modify the stored inspection data via the network using a web interface, and update the scheduling information based on the stored inspection data. A plurality of clients are operable to send the scheduling information to the mobile data collection devices and receive updated scheduling information based on the stored inspection data or program evaluation data.

### Network Environment

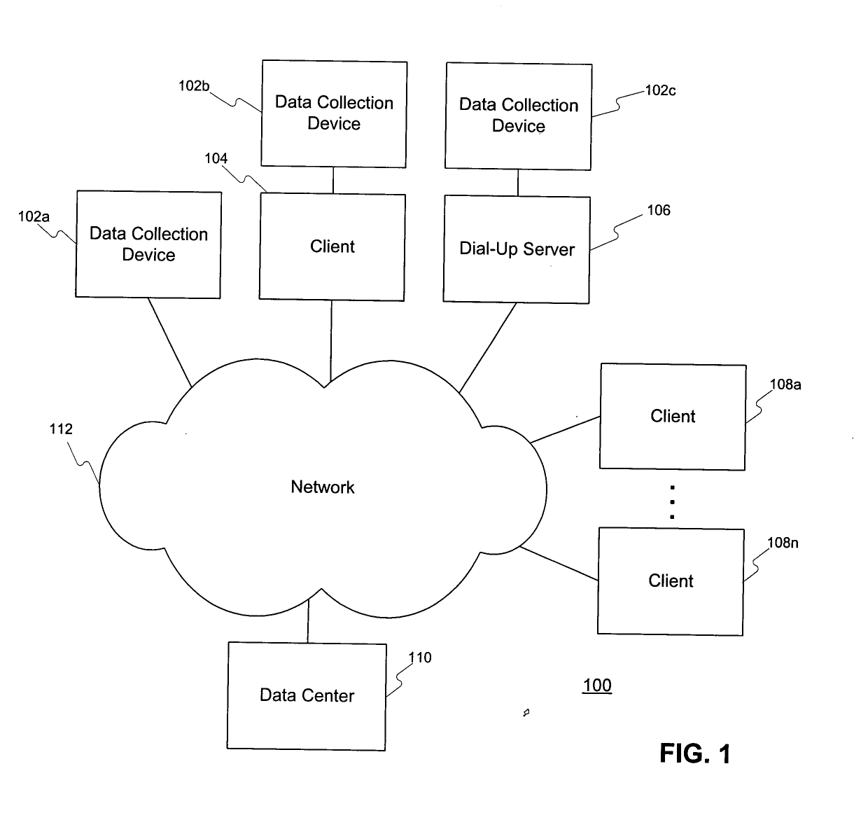

FIG. 1 is a block diagram of a network environment 100, in which features and aspects consistent with the present invention may be implemented. The number of components in environment 100 is not limited to what is shown and other variations in the number of arrangements of components are possible, consistent with embodiments of the invention. The components of FIG. 1 may be implemented through hardware, software, and/or firmware. Network environment 100 may include data collection devices 102a-102c, client 104, dial-up server 106, clients 108a-108n, data center 110, and network 112.

Data collection devices 102a-102c may be utilized by users to collect various inspection and evaluation data in the course of conducting inspections and/or program evaluations. A user may also upload such inspection and evaluation data to a remote location, such as data center 110, where it may be stored or otherwise processed. Data collection devices 102a-102c may be implemented using any appropriate mobile devices capable of receiving downloaded information related to inspections and/or program evaluations, receiving input from a user conducting an inspection and/or program evaluation, and uploading inspection and evaluation data. For example, data collection devices 102a-102c may be implemented using Pocket PC or Personal Digital Assistant (PDA) devices, such as those available from Compaq (e.g., Compaq IPAQ Pocket PC), HP, Toshiba, Symbol, Palm, Sony, Handspring, Acer, Dell, Fujitsu, etc.

Data collection device 102a may communicate directly with network 112 using a CompactFlash network interface card (NIC) or other similar interface. Data collection device 102b may be connected to client 104 so that data collection device 102b may send inspection and/or evaluation data to data center 110 via network 112 and client 104. For example, data collection device 102b may interface with client 104 using a cradle and a Universal Serial Bus (USB) connection or serial interface connection, or other mechanism for connecting a peripheral device to a PC. Data collection device 102b may also communicate with client 104 using Bluetooth technology. Data collection device 102b may synchronize with client 104 so that inspection and/or evaluation data may be transferred from data collection device 102b to client 104. In addition, information may be passed to data collection device 102b to client 104 in a similar manner. In order to synchronize data collection device 102b and client 104, synchronizing software such as Microsoft ActiveSync 3.5 or other similar software may be used.

Data collection device 102c may utilize dial-up server 106 in order to communicate with data center 110. For example, data collection device 102c may use a modem to establish communications with dial-up server 106 via a telephone network (not shown). Dial-up server 106 may pass data from data collection device 102c to data center 110 via network 12. In one embodiment, the modem may be a CompactFlash modem that supports V.90 and 56Kflex.

One of ordinary skill in the art will appreciate that while each of data collection device 102a, 102b, and 102c has been depicted as being connected to network 112 in different manners, each of these devices may connect to network 112 in multiple ways. For example, data collection device 102a may utilize a direct connection to the network, communicate with the network via a cradle and client, and/or communicate with the network via a dial-up server.

In one embodiment, data collection devices 102a-102c may also communicate directly with each other. For example, each of data collection device 102a-102c may send data to and receive data from another data collection device using Infrared Data Association (IrDA) transmissions or other similar transmissions. In this manner, a data collection device may also receive inspection and/or evaluation data from another data collection device.

Clients 108a-108n are operable, similar to data collection devices 102a-102c, to collect various inspection and evaluation data in the course of conducting inspections and/or program evaluations, and to upload such inspection and evaluation data to a remote location, such as data center 110, where it may be stored or otherwise processed. Clients 108a-108n are also operable to perform other functions related to inspections and program evaluations. Such functions may include inspection and program evaluation scheduling, hazard log data collection, and access to reports related to inspections, program evaluations, or hazard logs. For example, a user may utilize a user interface of one of the clients 108a-108n to enter inspection or program evaluation schedules, collect inspection or program evaluation data, collect hazard log data, and/or request a report on inspections, program evaluations, or hazard logs.

Scheduling information entered at a client may be sent directly to other clients and/or data collection devices. Those clients and data collection devices may be used to implement to the scheduled inspections and program evaluations. Scheduling information may also first be sent to data center 110, where the information may be processed and sent to the appropriate clients and/or data collection devices. Collected inspection and program evaluation data may be uploaded to data center 110, where it is stored for later use. Requests for reports are sent from a client to data center, where the reports may be generated and returned to the requester(s).

Clients 108a-108n may also optionally interface with a data collection device, in a manner similar to that shown for data collection device 102b and client 104. Moreover, client 104 may perform functions similar to those described above with reference to clients 108a-108n.

Data center 110 is operable to provide various server functions related to data collection and report generation. For example, data center 110 may receive inspection data, program evaluation data, and hazard log data, and store it in a database. Once in the database, this data can be further tracked and analyzed. Data center 110 may also generate reports on the stored data. These reports may be viewed locally at data center 110 or remotely at a client, such as one of clients 104 or 108a-108n.

Network 112 provides communications between the various entities depicted in network environment 100. Network 112 may be one or more shared, public, or private networks and encompass a wide area or local area. Network 112 may be implemented through any suitable combination of wired and/or wireless communication networks. By way of example, Network 112 may be implemented through a wide area network (WAN), local area network (LAN), an intranet and/or the Internet.

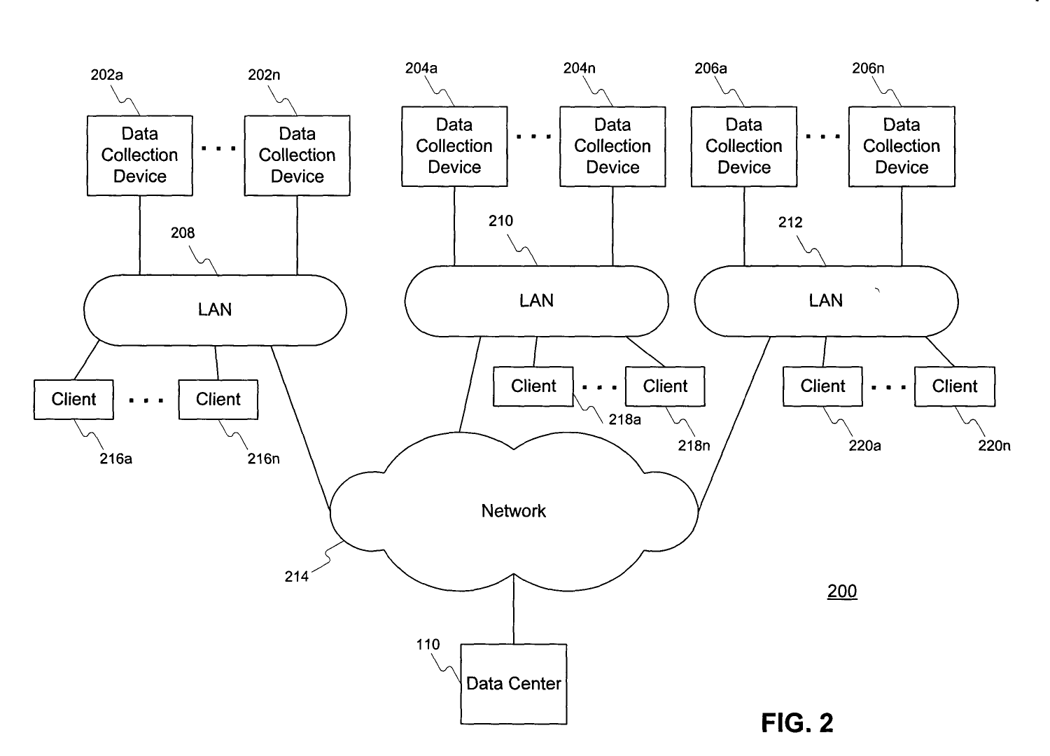

FIG. 2 is a diagram of another exemplary network environment 200, in which features and aspects consistent with the principals of the present invention may be implemented. The number of components in environment 200 is not limited to what is shown and other variations in the number of arrangements of components are possible, consistent with embodiments of the invention. The components of FIG. 2 may be implemented through hardware, software, and/or firmware. Network environment 200 may include data collection devices 202a-202n, data collection devices 204a-204n, data collection devices 206a-206n, LAN 208, clients 216a-216n, LAN 210, clients 218a-218n, LAN 212, clients 220a-22n, data center 110 and network 214.

Data collection devices 202a-202n, 204a-204n, and 206a-206n provide similar functions as those describe above for data collection devices 102a-102c with reference to FIG. 1. In addition, clients 216a-216n, 218a-218n, and 220a-220n provide similar functions as those describe above for clients 104 and 108a-108n with reference to FIG. 1. Moreover, data center 110 provides similar functions as those describe above with reference to FIG. 1. In FIG. 2, however, data collection devices 202a-202n, 204a-204n, and 206a-206n are specifically depicted as being connected to different networks, namely LANs 208, 210, and 212. Clients 216a-216n, 218a-218n, and 220a-220n are also specifically depicted as being connected to different networks. For example, LANs 208, 210, and 212 may all be local networks that are affiliated with the same business organization. Various inspections and program evaluations may be scheduled within the business organization and implemented using the clients and/or data collection devices. Other functions consistent with the principles of the present invention may also be performed, such as hazard log data collection and data reporting. One of ordinary skill in the art will appreciate that a data collection device 202, 204, or 206 may utilize similar manners of connecting to its respective LAN as explained above with reference to data collection devices 102a-102c (e.g., direct connection, through a client, or through a dial-up server).

Network 214 provides communications between the various entities depicted in network environment 200. Network 214 may be one or more shared, public, or private networks encompassing a wide area. Network 214 may be implemented through any suitable combination of wired and/or wireless communication networks. By way of example, Network 214 may be implemented through a wide area network (WAN) and/or the Internet.

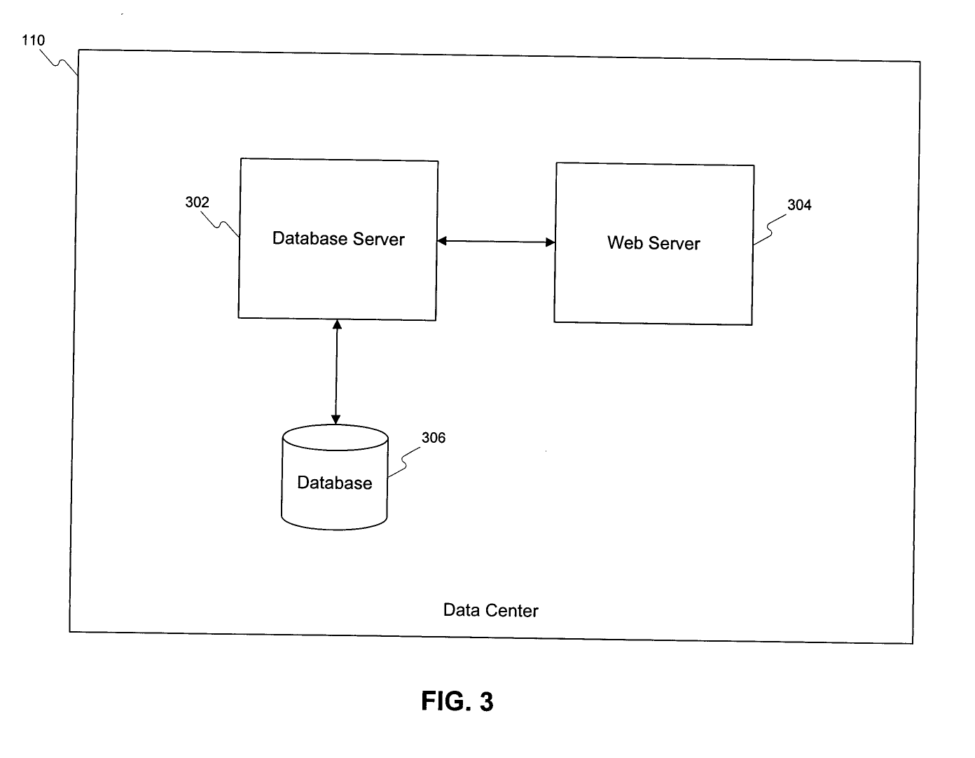

FIG. 3 is a diagram of an exemplary data center consistent with the present invention. Data center 110 may include at least a database server 302, web server 304, and a database 306. The number of components in environment 100 is not limited to what is shown and other variations in the number of arrangements of components are possible, consistent with embodiments of the invention.

Database server 302 provides access to and otherwise manages database 306, where various collected data may be stored. For example, collected inspection data, program evaluation data, and hazard log data received from data collection devices and clients may be stored in database 306. Database server 302 may also provide access to database 306 for the storage of inspection and program evaluation scheduling information, and report information. One of ordinary skill in the art will appreciate that while database 306 and database server 302 are depicted in FIG. 3 as being separate, they may be implemented as part of the same unit.

Web server 304 provides functionality for receiving traffic over a network from a data collection device or client. For example, web server 304 may be a standard web server that a user may access at a data collection device or client using a web browser program, such as Internet Explorer, Pocket Internet Explorer, or Netscape Communicator.

Web server 304 is operable to receive collected inspection, program evaluation, and hazard log data from data collection devices and clients, and pass the data on to database server 302 for storage in database 306. Web server 304 is also operable to receive or generate scheduling data and propagate the scheduling data to the appropriate data collection devices and clients. For example, a user may schedule inspections to occur at various sites, where other users may utilize data collection devices or clients to collect data. The scheduling user may enter a schedule of inspections at a client and send the schedule to web server 304, which may subsequently send appropriate scheduling indicators to the data collection devices and/or clients that may be involved in the scheduled inspections. Alternatively, the scheduling user may enter the scheduling information directly at web server 304 instead of at a client. One of ordinary skill in the art will appreciate that scheduling information for program evaluations may also be propagated in the manner described above.

Additionally, web server 304 may receive requests for reports on inspections, program evaluations, hazard logs, etc., from a client. Upon receiving such a request, web server 304 may access relevant data stored locally or in database 306 and generate an appropriate report. The report may then be sent to the requesting client via a network, such as network 112 or 214.

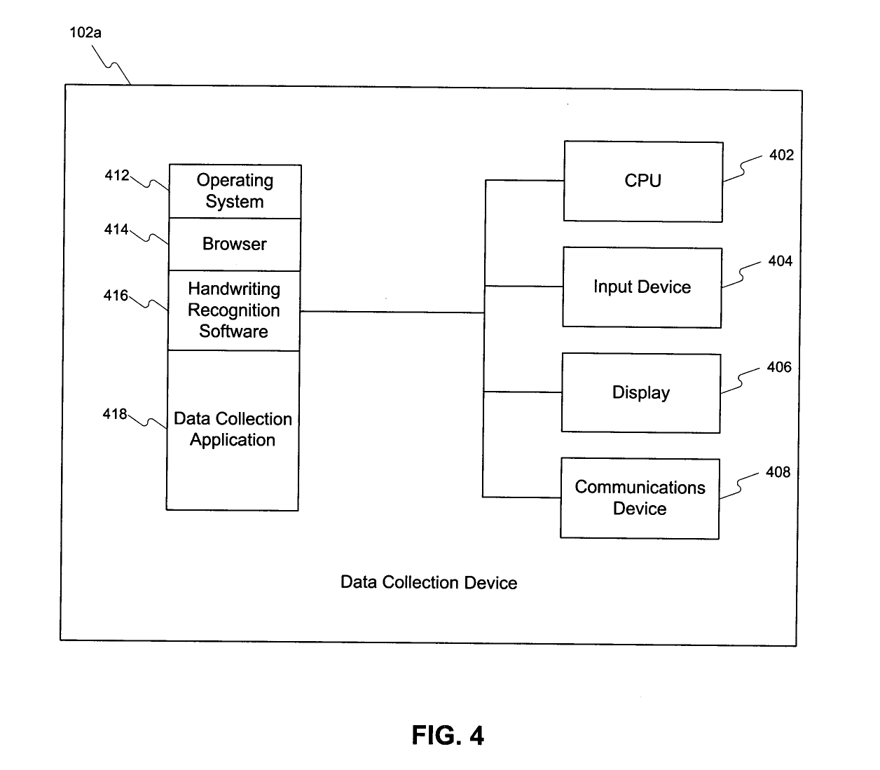

FIG. 4 is a diagram of an exemplary data collection device consistent with the principals of the present invention. A data collection device, such as data collection device 102a may include a CPU 402, an input device 404, a display 406, a communications device 408, and a memory 410. Memory 410 may include operating system 412, browser 414, handwriting recognition software 416, and data collection application 418. The number of components in data collection device 102a is not limited to what is shown and other variations in the number of arrangements of components are possible, consistent with embodiments of the invention. One of ordinary skill in the art that the other data collection devices depicted in FIGS. 1 and 2 may be similar to data collection device 102a.

CPU 402 may be one or more known processing devices, such as a Pentium™ microprocessor manufactured by Intel Corporation or a StrongARM SA-1110 RISC processor also manufactured by Intel Corporation. Input device 404 may be any mechanism usable by a user to enter input into data collection device 102a. Such mechanisms include a portable keyboard, a mouse, an on-screen keyboard, etc. Display 406 may be any monitor suitable for a mobile unit, such as a touch sensitive LCD of appropriate size. Communication device 408 may include, for example, a CompactFlash NIC (network interface card), an ActiveSync cradle, and/or a 56K modem.

Memory 410 may be one or more storage devices configured to store data used by CPU 402 to perform certain functions related to embodiments of the present invention. Memory 410 may be a magnetic, semiconductor, tape, or optical type of storage device. For example, in one embodiment memory 410 may include a 64 MB SDRAM and a 32 MB Flash ROM. Operating system 412 may be implemented using any operating system suitable for a Pocket PC or PDA. One such operating system is Pocket PC 2000 manufactured by Microsoft Corporation. Browser 414 may be any browser suitable for a Pocket PC or PDA, such as Pocket Internet Explorer. Handwriting recognition software 416 may be implemented, for example, using Transcriber 1.5, or other similar software.

Data collection application 418 is operable to enable a user to enter inspection, program evaluation data, and hazard log data using a user interface. This data may be subsequently stored in database 306, sent to another data collection device, sent to a client, etc. Data collection application 418 may be implemented in any appropriate programming language or environment such as Java™, Visual Basic, C++, etc.

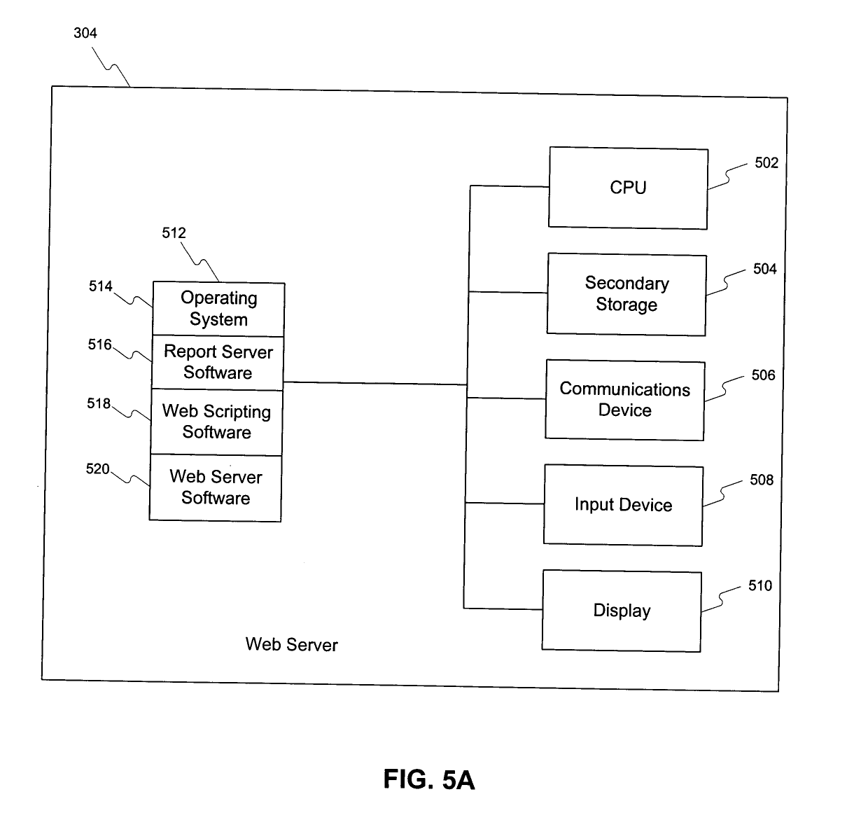

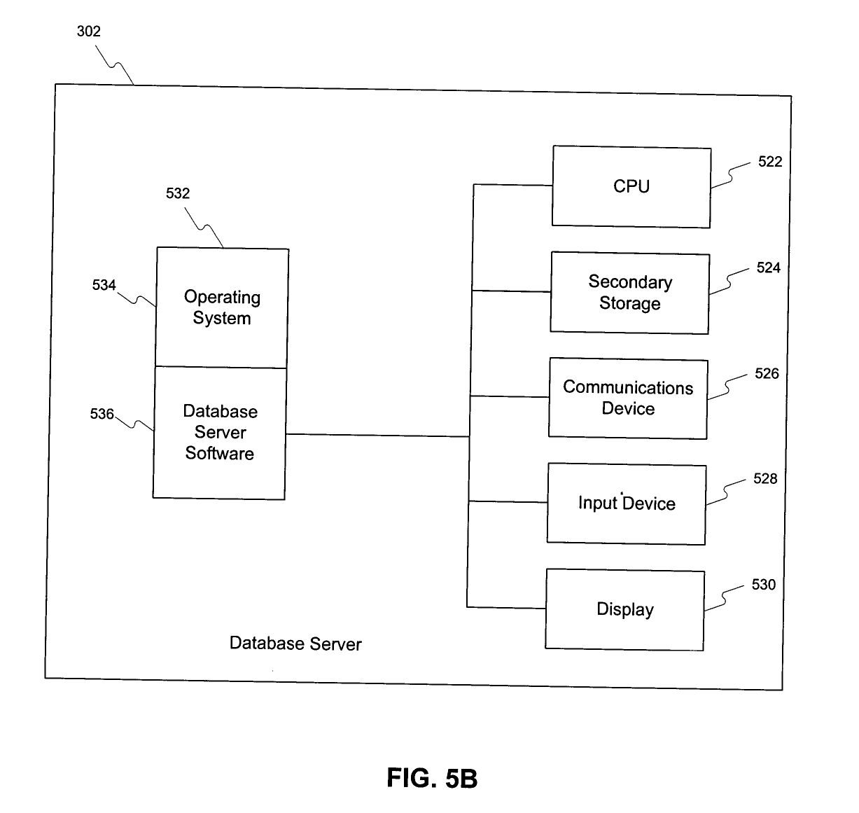

FIG. 5A is a diagram of an exemplary web server 304, consistent with the principals of the present invention. A web server 304 may include a CPU 502, a secondary storage 504, a communications device 506, an input device 508, a display 510, and a memory 512. The number of components in web server 304 is not limited to what is shown and other variations in the number of arrangements of components are possible, consistent with embodiments of the invention.

CPU 502 may be one or more known processing devices, such as a Pentium™ microprocessor manufactured by Intel Corporation. Secondary storage 504 may be one or more data storage mediums such as a hard drive, CD-ROM drive, DVD drive, floppy drive, etc. In one embodiment, secondary storage 504 may include a 9.1 GB Ultra3 SCSI hard drive (used with wide Ultra2/Ultra3 Hot Plug drive bays, Integrated Smart Array controller, and RAID 5 setting) and a 3.5 ″ 1.44 MB floppy drive. Control of the web server 304 as well as data input by a user may be achieved through input device 508, which may comprise a keyboard, a pointer device, a mouse, etc. Data output may be presented to a user of the web server through display 510 and/or another output device (such as a printer—not shown).

Memory 512 may be one or more storage devices configured to store data used by CPU 502 to perform certain functions related to embodiments of the present invention. Memory 512 may be a magnetic, semiconductor, tape, or optical type of storage device. In one embodiment, memory 512 may be a 133 Mhz 1 GB SDRAM. Software and other applications may be loaded into secondary storage 504 and/or memory 512 using, for example, a computer readable medium with a software or program application that is read by secondary storage 504. Software may also be installed via network 112 and communications device 506.

Memory 512 may include operating system 514, report server software 516, web scripting software 518, and web server software 520. Operating system 514 may be implemented using any suitable server operating system, such as Windows 2000 Server manufactured by Microsoft Corporation. Report server software 516 may be operable to generate web reports of data stored locally or remotely in response to a received report request. For example, report server software 516 may create a web report based on collected inspection, program evaluation, and/or hazard log data that is stored in database 306. Such a web report may be presented to a user local to web server 304 or sent to a remote user, such as a user of a client 108a. In one embodiment, report server software 516 may be implemented using a program such as Oracle Reports Server 6.

Web scripting software 518 may be operable to build interactive web pages. In one embodiment, web scripting software 518 may be implemented using a program such as Active Server Pages 3.0. Web server software 520 may be operable to send out web pages in response to requests from remote browsers. In one embodiment, web server software 520 may be implemented using a program such as Microsoft Internet Information Server available from Microsoft Corporation.

FIG. 5B is a diagram of an exemplary database server 302, consistent with the principals of the present invention. A database server 302 may include a CPU 522, a secondary storage 524, a communications device 526, an input device 528, a display 530, and a memory 532. The number of components in database server 302 is not limited to what is shown and other variations in the number of arrangements of components are possible, consistent with embodiments of the invention.

CPU 522 may be one or more known processing devices, such as a PentiuM™ microprocessor manufactured by Intel Corporation. Secondary storage 524 may be one or more data storage mediums such as a hard drive, CD-ROM drive, DVD drive, floppy drive, etc. In one embodiment, secondary storage 524 may include a 9.1 GB Ultra3 SCSI hard drive (used with wide Ultra2/Ultra3 Hot Plug drive bays, Integrated Smart Array controller, and RAID 5 setting) and a 3.5″ 1.44 MB floppy drive. Control of the database server 302 as well as data input by a user may be achieved through input device 528, which may comprise a keyboard, a pointer device, a mouse, etc. Data output may be presented to a user of the web server through display 530 and/or another output device (such as a printer—not shown).

Memory 532 may be one or more storage devices configured to store data used by CPU 522 to perform certain functions related to embodiments of the present invention. Memory 532 may be a magnetic, semiconductor, tape, or optical type of storage device. In one embodiment, memory 532 may be a 133 Mhz 1 GB SDRAM. Software and other applications may be loaded into secondary storage 524 and/or memory 532 using, for example, a computer readable medium with a software or program application that is read by secondary storage 524. Software may also be installed via network 112 and communications device 526.

Memory 532 may include operating system 534 and database server software 536. Operating system 534 may be implemented using any suitable server operating system, such as Windows 2000 Server manufactured by Microsoft Corporation. Database server software 536 may be operable to manage access to database 306. In one embodiment, database server software 536 may be implemented using a program such as Oracle database server.

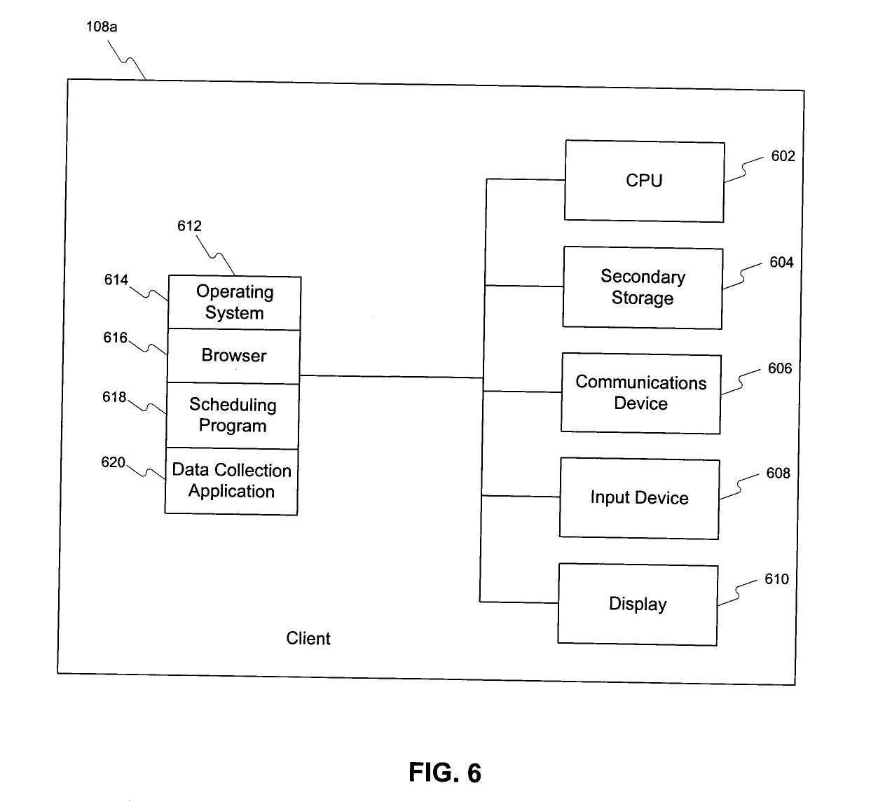

FIG. 6 is a diagram of an exemplary client, consistent with the principals of the present invention. A client, such as client 108a may include a CPU 502, a secondary storage 504, a communications device 506, an input device 508, a display 510, and a memory 512. The number of components in client 108a is not limited to what is shown and other variations in the number of arrangements of components are possible, consistent with embodiments of the invention. One of ordinary skill in the art that the other clients depicted in FIGS. 1 and 2 may be similar to data collection device 108a.

CPU 602 may be one or more known processing devices, such as a Pentium™ microprocessor manufactured by Intel Corporation. Secondary storage 604 may be one or more data storage mediums such as a hard drive, CD-ROM drive, DVD drive, floppy drive, etc. Control of client 108a as well as data input by a user may be achieved through input device 608, which may comprise a keyboard, a pointer device, a mouse, etc. Data output may be presented to a user of the web server through display 610 and/or another output device (such as a printer—not shown).

Memory 612 may be one or more storage devices configured to store data used by CPU 602 to perform certain functions related to embodiments of the present invention. Memory 612 may be a magnetic, semiconductor, tape, or optical type of storage device. Software and other applications may be loaded into secondary storage 604 and/or memory 612 using, for example, a computer readable medium with a software or program application that is read by secondary storage 604. Software may also be installed via network 112 and communications device 606.

Memory 612 may include operating system 514, browser 616, scheduling program 618, and data collection application 620. Operating system 614 may be implemented using any operating system suitable for a desktop or laptop computer, such as Windows 2000 manufactured by Microsoft Corporation. Browser 616 may be implemented using any Internet browser suitable for a desktop or laptop computer, such as Internet Explorer manufactured by Microsoft Corporation.

Scheduling program 618 may be operable to implement the scheduling operations of the present invention. For example, scheduling program 618 may schedule various inspections and program evaluations to be implemented by users of different data collection devices and/or clients. Data collection application 620 may be operable to enable a user to enter inspection, program evaluation data, and hazard log data using a user interface. This data may be subsequently stored in database 306, sent to a data collection device, sent to another client, etc. Scheduling program 618 and data collection application 620 may be implemented in any appropriate programming language or environment such as Java™, Visual Basic, C++, etc.

### System Operation

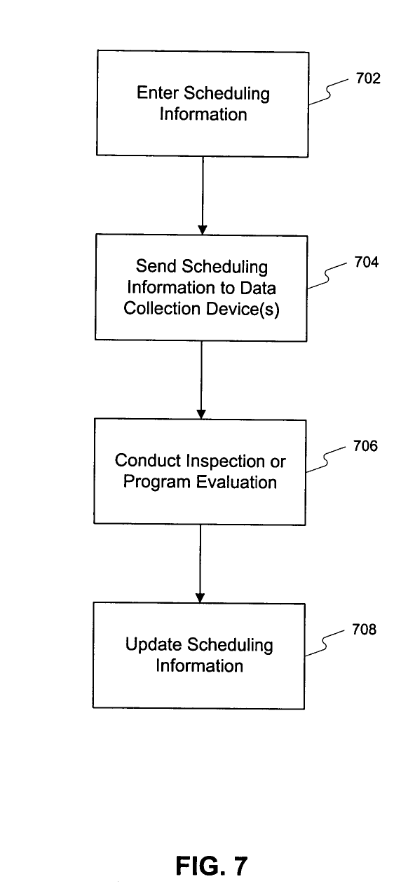

FIG. 7 is a diagram of an exemplary flowchart of a method for inspection and PEG (Program Evaluation Guide) scheduling for large facilities consistent with the present invention. Although the steps of the flowchart are described in a particular order, one skilled in the art will appreciate that these steps may be performed in a modified or different order. Further, one or more of the steps in FIG. 7 may be performed concurrently or in parallel.

The method of FIG. 7, for example, enables safety specialist and managers to manage the safety inspection and PEG efforts of inspectors and PEG team members. A program evaluation guide, whether it be for a large or small facility, is a tool for use and assistance in evaluating an organization's safety and health guidelines, for example. A typical program evaluation may have several elements and factors that may each be scored, indicating the level of the safety and health program. The scores of each element and factor may be combined in some manner to create an overall score. Exemplary elements and factors may include at least some of management leadership, employee participation, implementation, contractor safety, survey and hazard analysis, inspection program, hazard reporting, accident investigation, data analysis of accidents, hazard control and maintenance, medical program, emergency preparedness and first aid, and safety and health training.

A user desiring to set a schedule for either inspections or program evaluations may first enter scheduling information (step 702). The user may enter the scheduling information, for example, at a client, such as client 108a or 216a. Scheduling information may include required inspection and/or program evaluation completion dates, which refer to dates by which an inspection or program evaluation must be finished. In other words, if an inspection or program evaluation is conducted before or on a given completion date, the inspection or program evaluation is in compliance with the required completion date. Additionally, scheduling information may include dates on which inspections and/or program evaluations are to be conducted. In one embodiment, a scheduling program 618 may be operable to receive the scheduling information. The scheduling information may be saved local to the computer on which it was entered or may be sent, for example, to database 306 at data center 110 for storage. One of ordinary skill in the art will appreciate that the scheduling information may also be maintained at other locations other than a client 108 or data center 110.

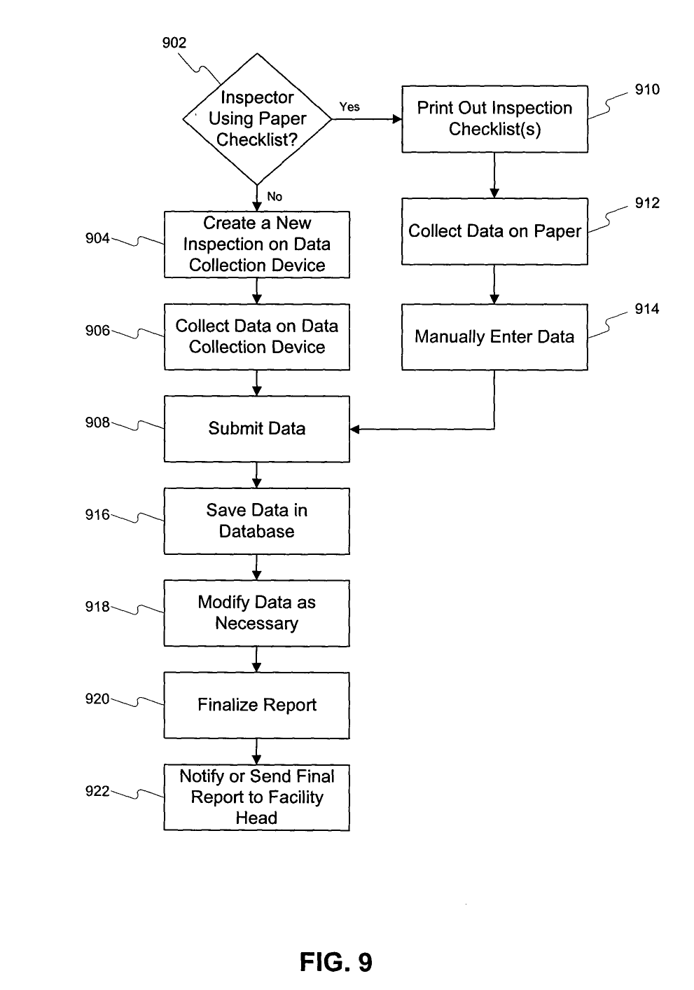

Once the user enters and saves the scheduling information, the user may indicate that the information should be sent to the various inspectors and/or PEG team members. In response, scheduling program 618 may send the scheduling information to the data collection device(s) and/or client(s) corresponding to the inspectors and/or PEG team that are to perform the inspection(s) and/or program evaluation(s) (step 704). Thereafter, the inspector(s) or PEG team members may conduct the inspection or program evaluation (step 706). Inspections and program evaluations are explained more fully below with respect to FIGS. 9-11.

Upon completion of an inspection or program evaluation, the inspector or PEG team member may provide information on the inspection or program evaluation results and the completion date to the computer where the scheduling information was initially entered. For example, an inspector may send inspection results and completion date information from a data collection device 102a to a client 108a, where a user originally generated the scheduling information. Alternatively, inspection results and completion date information may be sent to data center 110 or any other location where the scheduling information related to the inspection is being stored.

Based on the received inspection results and completion date information, scheduling program 618 may update the stored scheduling information (step 708). For example, if the received completion date information reflects that the inspection or program evaluation was completed on time, then an indication to that effect may be associated with the entry for the inspection or program evaluation. In addition, an indication that the inspection or program evaluation was completed as well as the completion date may be associated with the entry for the inspection or program evaluation. Moreover, in one embodiment, scheduling program 618 may normally send periodic reminders of an inspection or program evaluation before the inspection or program evaluation has been completed. Upon receiving an indication that the inspection or program evaluation is finished, scheduling program 618 may cease to send such reminders.

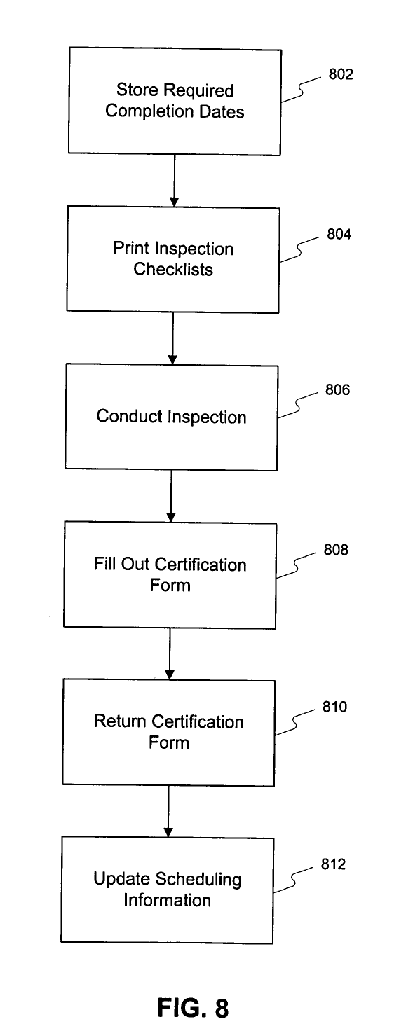

FIG. 8 is a diagram of an exemplary flowchart of a method for inspection and SFPEG (Small Facility Program Evaluation Guide) scheduling for small facilities consistent with the present invention. Although the steps of the flowchart are described in a particular order, one skilled in the art will appreciate that these steps may be performed in a modified or different order. Further, one or more of the steps in FIG. 8 may be performed concurrently or in parallel.

The method of FIG. 8, for example, enables safety specialist and managers to manage the safety inspection and SFPEG efforts of inspectors and SFPEG team members. A database administrator or similar official may store the required completion dates for inspections and program evaluations in a database, such as database 306 located at data center 110 (step 802). Completion dates may refer to dates by which an inspection or program evaluation must be finished. In other words, if an inspection or program evaluation is conducted before or on a given completion date, the inspection or program evaluation is in compliance with the required completion date. The database administrator may also store information reflective of dates on which inspections and/or program evaluations are to be conducted. One of ordinary skill in the art will appreciate that the date information may also be maintained at other locations other than data center 110.

After the completion dates have been entered, inspection checklists may be printed (step 804). These inspection checklists may include information reflective of the required completion dates as well as specific tasks to be performed during particular inspections and/or program evaluations. The checklists may be sent to the various inspectors and/or SFPEG team members that are to perform the inspection(s) and/or program evaluation(s). Alternatively, the inspection checklists may be sent to the inspectors or SFPEG team members electronically, who may thereafter print the inspection checklist(s). After the inspectors or SFPEG team members have received the relevant checklist(s), the inspector(s) or SFPEG team members may conduct the inspection or program evaluation (step 806). Inspections and program evaluations are explained more fully below with respect to FIGS. 9-12.

Upon completion of an inspection or program evaluation, the inspector or SFPEG team member may fill out an appropriate certification form (step 808). On the form, the inspector or SFPEG team member may provide information on the inspection or program evaluation results and the completion date. The inspector or SFPEG team member subsequently returns the certification form to an appropriate official (step 810). In one embodiment, the form may be an electronic form that may be sent to the official electronically, who may thereafter print the certification form.

Based on the received inspection results and completion date information, the official that received the completed certification form may update the stored scheduling information (step 812). For example, if the received completion date information reflects that the inspection or program evaluation was completed on time, then an indication to that effect may be associated with the entry for the inspection or program evaluation. In addition, an indication that the inspection or program evaluation was completed as well as the completion date may be associated with the entry for the inspection or program evaluation.

FIG. 9 is a diagram of an exemplary flowchart of a method for inspection data collection for a single inspector consistent with the present invention. Although the steps of the flowchart are described in a particular order, one skilled in the art will appreciate that these steps may be performed in a modified or different order. Further, one or more of the steps in FIG. 9 may be performed concurrently or in parallel.

First, a determination is made as to whether the inspector will use a paper checklist (step 902). If a paper checklist is not being used (e.g., data is to be entered on a data collection device), then the inspector may create a new inspection instance on a data collection device or client being used by the inspector (step 904). For example, the inspector may use an input device to indicate that a new inspection is to be opened by a data collection application 418 or 620. Next, the inspector may proceed to conduct the inspection and collect data on a data collection device (e.g., data collection device 102a) (step 906). In one embodiment, data collection application 418 or 620 may be responsible for collecting the data entered by the inspector.

Once data collection application 418 or 620 has received all of the inspection data, it may submit the data by sending the inspection data to database 306 at data center 110 for storage (step 908). Data collection application 418 or 620 may initiate the sending operation in response to the inspector using an input device to indicate that data should be submitted, or data may be periodically sent automatically. One of ordinary skill in the art will recognize that data may be submitted to database 306 before the inspection is completed. For example, in cases where the inspection is not completed in a continuous span of time, it may be necessary to save the inspection data locally or remotely (e.g., at database 306), so that the inspection may be completed at a later time.

If the inspector is using a paper checklist, then the inspector may print out an inspection checklist for use during the inspection (step 910). For example, a printer located at a client 108 may be used to print the checklist. The inspector may then proceed to collect inspection data on paper (step 912). Upon completion of the inspection, the inspector may manually enter the inspection data into a computer, such as client 108. For example, data collection application 620 may be operable to receive the inspection data that is input by the inspector. Thereafter, data collection application 620 may submit the inspection data as was described above with reference to step 908.

Once data has been submitted to data center 110, the inspection data may be stored in database 306 (step 916). The inspector may review the stored inspection data and modify the data as necessary (step 918). For example, the inspector may access the inspection data via network 112 or 214. The inspection data may be presented to the inspector using a web page or other suitable manner. The inspector may enter modification data on the web page and submit the data.

Additionally, the inspector may have also previously notified another official, such as a facility head, that the inspection data is available, for example, on the Web. The facility head may view the inspection data but may not modify it.

After the inspection data has been modified (e.g., if any modification were needed), the inspector may finalize the inspection report (step 920). For example, the inspector may use an input device to indicate to a data collection application 418 or 620 that the inspection report is final. Data collection application 418 or 620 may send data to database 306 indicative of the finality of the inspection report and cause an indication to that effect to be stored with the inspection data. Any attempts to thereafter modify that data may not be successful.

Once the report has been finalized, the inspector may notify another official, such as a facility head, that the report is final (step 922). Such a notification may be sent to the facility in any number of ways. For example, data collection application 418 or 620 may send an electronic notification to the facility head at an appropriate location. Alternatively, the inspector may inform the facility head in person, via the telephone, etc.

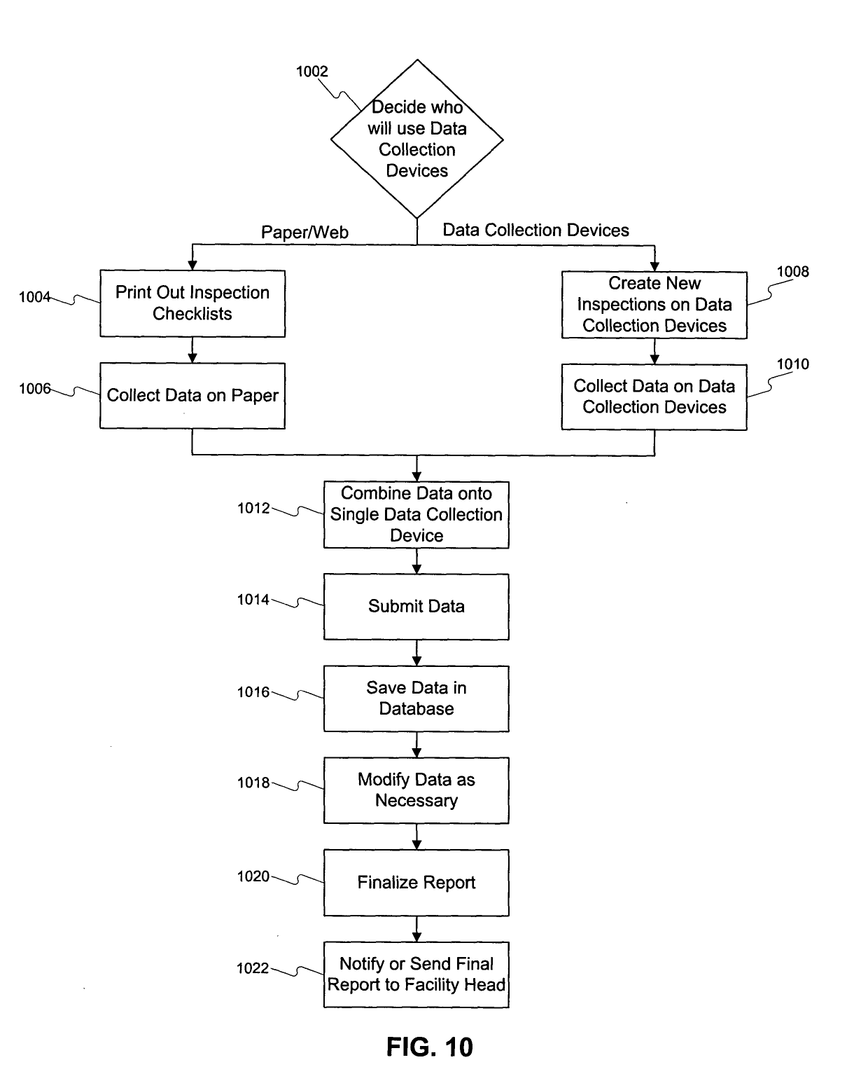

FIG. 10 is a diagram of an exemplary flowchart of a method for inspection data collection for multiple inspectors consistent with the present invention. Although the steps of the flowchart are described in a particular order, one skilled in the art will appreciate that these steps may be performed in a modified or different order. Further, one or more of the steps in FIG. 10 may be performed concurrently or in parallel.

Before an inspection involving multiple inspectors may be conducted, a decision needs to be made as to which inspectors will use data collection devices to conduct the inspection and which inspectors will use another method, such as a paper checklist (step 1002). It may be possible for all of the inspectors to use data collection devices or for all of the inspectors to use another method of collecting data. If a data collection device is being used, then the inspector(s) may each create a new inspection instance on a data collection device being used by the inspector (step 1008). For example, each inspector may use an input device to indicate that a new inspection is to be opened by a data collection application 418 or 620. Next, each inspector may proceed to conduct the inspection and collect data on a data collection device (e.g., data collection device 102a) (step 1010). In one embodiment, data collection application 418 or 620 may be responsible for collecting the data entered by the inspector.

If an inspector is using a paper checklist, then the inspector may print out an inspection checklist for use during the inspection (step 1004). For example, a printer located at a client 108 may be used to print the checklist. The inspector may then proceed to collect inspection data on paper (step 1006). Upon completion of the inspection, the inspector may manually enter the inspection data into a computer, such as client 108. For example, data collection application 620 may be operable to receive the inspection data that is input by the inspector.

As each inspector finishes collecting inspection data, each inspector proceeds to combine the inspection data onto a single data collection device or client (step 1012). For example, prior to the inspection effort, the inspectors may designate one data collection device or client to receive the collective inspection data from all of the inspectors. Inspection data transmission may be from data collection device to data collection device (e.g., using IrDA transmission), from data collection device to client, or from client to data collection device. Additionally, inspectors may enter inspection data from a paper checklist directly to the designated data collection device or client.

Once the designated data collection device or client has received all of the inspection data, it may submit the data by sending the inspection data to database 306 at data center 110 for storage (step 1014). The designated data collection device or client may initiate the sending operation in response to the inspector using an input device to indicate that data should be submitted, or data may be periodically sent automatically. One of ordinary skill in the art will recognize that data may be submitted to database 306 before the inspection is completed. For example, in cases where the inspection is not completed in a continuous span of time, it may be necessary to save the inspection data locally or remotely (e.g., at database 306), so that the inspection may be completed at a later time.

Once data has been submitted to data center 110, the inspection data may be stored in database 306 (step 1016). The lead inspector (e.g., the inspector that corresponds to the designated data collection device or client) may review the stored inspection data and modify the data as necessary (step 1018). For example, the lead inspector may access the inspection data via network 112 or 214. The inspection data may be presented to the lead inspector using a web page or other suitable manner. The lead inspector may enter modification data on the web page and submit the data. Additionally, the lead inspector may have also previously notified another official, such as a facility head, that the inspection data is available, for example, on the Web. The facility head may view the inspection data but may not modify it.

After the inspection data has been modified (e.g., if any modification were needed), the lead inspector may finalize the inspection report (step 1020). For example, the inspector may use an input device to indicate to a data collection application 418 or 620 that the inspection report is final. Data collection application 418 or 620 may send data to database 306 indicative of the finality of the inspection report and cause an indication to that effect to be stored with the inspection data. Any attempts to thereafter modify that data may not be successful.

Once the report has been finalized, the lead inspector may notify another official, such as a facility head, that the report is final (step 1022). Such a notification may be sent to the facility in any number of ways. For example, data collection application 418 or 620 may send an electronic notification to the facility head at an appropriate location. Alternatively, the lead inspector may inform the facility head in person, via the telephone, etc.

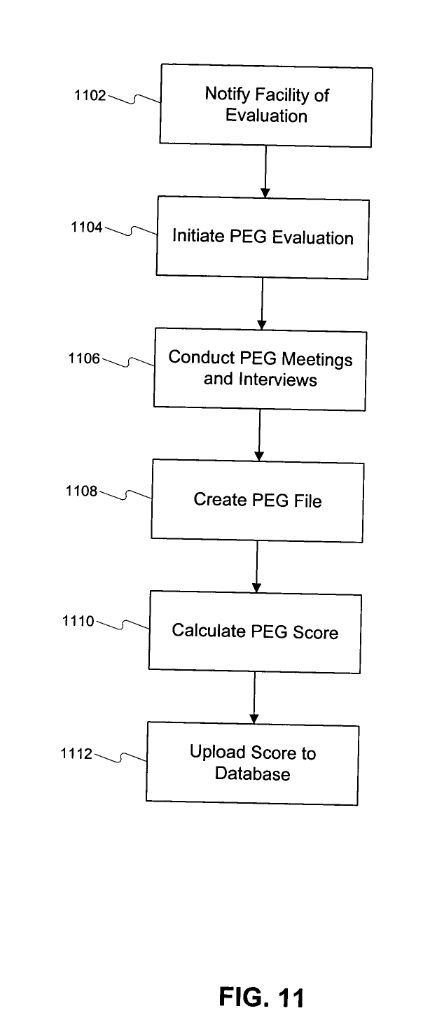

FIG. 11 is a diagram of an exemplary flowchart of a method for PEG or SFPEG data collection consistent with the present invention. Although the steps of the flowchart are described in a particular order, one skilled in the art will appreciate that these steps may be performed in a modified or different order. Further, one or more of the steps in FIG. 11 may be performed concurrently or in parallel.

PEG or SFPEG evaluator notifies a facility that it will be the subject of a program evaluation (step 1102). Notification may be implemented using either manual or electronic means. The facility may be granted a period of time to prepare for the program evaluation. At the end of any period of time given for preparation, the program evaluation may be initiated (step 1104). The PEG or SFPEG team members may meet with various employees of the facility to learn about the various safety and health program the facility has in place (step 1106). The PEG or SFPEG team leader may also create a new PEG or SFPEG file so that data collection may commence (step 1108). For example, the team leader may use an input device from a data collection device 102a or a client 108 to indicate that a new PEG or SFPEG file is to be opened by a data collection application 418 or 620. Next, the team leader may proceed to collect data related to the program evaluation on a data collection device (e.g., data collection device 102a). Alternatively, the PEG or SFPEG team leader may collect data using paper and later enter the collected data on a client 108.

After all of the program evaluation data has been entered, the PEG or SFPEG team may analyze the collected data to assign different scores to different parts of the facility's safety and health program. Based on the various scores associated with the safety and health program, the PEG or SFPEG team may calculate an overall PEG or SFPEG score (step 1110). Alternatively, data collection application 418 or 620 may automatically generate a PEG or SFPEG score based on the collected program evaluation data. Once data collection application 418 or 620 has received all of the program evaluation data and PEG or SFPEG score, it may submit the data by sending the inspection data to database 306 at data center 110 for storage (step 1112).

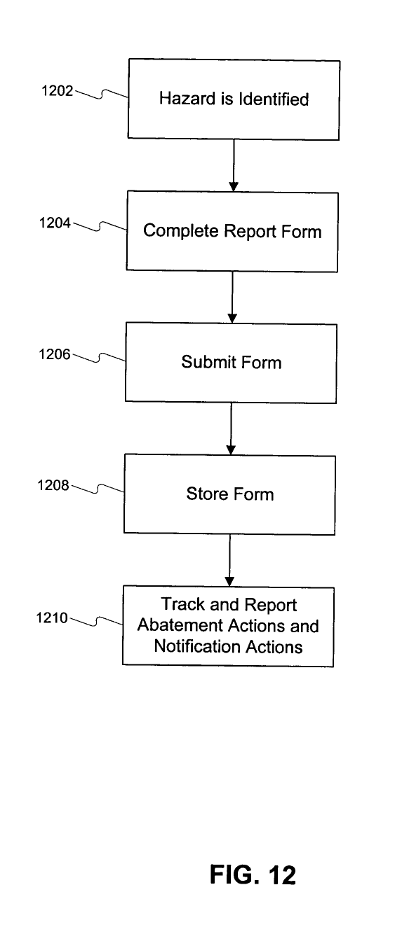

FIG. 12 is a diagram of an exemplary flowchart of a method for hazard log data collection consistent with the present invention. Although the steps of the flowchart are described in a particular order, one skilled in the art will appreciate that these steps may be performed in a modified or different order. Further, one or more of the steps in FIG. 12 may be performed concurrently or in parallel.

An employee first identifies a potential hazard, unsafe condition, or unsafe practice (step 1202). The identifying employee may then complete an appropriate report form (step 1204). A hazard report form may either be a paper or electronic form. If the form is an electronic form, then data collection application 418 or 620 may receive hazard information from the employee and populate the electronic form. Data collection application 1206 may then submit the hazard data from the form to data center 110 (step 1206). At data center 110, the hazard data is stored in database 306 (step 1208). Thereafter, abatement and notification actions concerning the reported hazard, condition, or practice may be tracked and periodically reported (step 1210). For example, an indication of anything that is done to attempt to eliminate the problem may be stored in database 306, along with a date of any such action. An indication of an employee reporting further incidents regarding the problem may also be stored. Report server software 516 may periodically generate reports on the status of different hazards, conditions, and practices.

While the present invention has been described in connection with various embodiments, many modifications will be readily apparent to those skilled in the art. One skilled in the art will also appreciate that all or part of the systems and methods consistent with the present invention may be stored on or read from computer-readable media, such as secondary storage devices, like hard disks, floppy disks, and CD-ROM;

a carrier wave received from a network such as the Internet; or other forms of ROM or RAM. Accordingly, embodiments of the invention are not limited to the above described embodiments and examples, but instead is defined by the appended claims in light of their full scope of equivalents.

What is claimed is:

1. A method for performing a facility inspection, comprising:
receiving scheduling information corresponding to an inspection to be performed at a facility;
collecting inspection data corresponding to the inspection to be performed at the facility;
storing the inspection data in a database;
modifying the stored inspection data using a web interface; and
updating the scheduling information based on the stored inspection data.

2. The method of claim 1, wherein receiving scheduling information comprises receiving a required completion date for the inspection to be performed at the facility.

3. The method of claim 1, wherein collecting inspection data comprises:
collecting data from a single inspector using a mobile data collection device.

4. The method of claim 1, wherein collecting inspection data comprises:
collecting data from a plurality of inspectors using mobile data collection devices;
combining the data from the plurality of inspectors onto a single mobile data collection device.

5. The method of claim 1, further comprising:
receiving periodic reminders of the inspection to be completed at the facility.

6. The method of claim 5, further comprising:
ceasing to receive the periodic reminders of the inspection to be completed at the facility, once the inspection data has been collected and stored.

7. A method for performing a facility program evaluation, comprising:
receiving scheduling information corresponding to a program evaluation to be performed at a facility, the program evaluation being for use in rating safety and health guidelines at the facility;
collecting program evaluation data corresponding to the program evaluation to be performed at the facility;
calculating a score associated with the program evaluation;
storing the program evaluation data and calculated score in a database; and
updating the scheduling information based on the stored program evaluation data and calculated score.

8. The method of claim 7, wherein receiving scheduling information comprises receiving a required completion date for the program evaluation to be performed at the facility.

9. The method of claim 7, further comprising:
receiving periodic reminders of the program evaluation to be completed at the facility.

10. The method of claim 9, further comprising:
ceasing to receive the periodic reminders of the program evaluation to be completed at the facility, once the program evaluation data has been collected and stored.

11. A method for performing a facility inspection, comprising:
sending, to at least one mobile data collection device, scheduling information corresponding to an inspection to be performed at a facility;
transmitting, to each mobile collection device, periodic reminders of the inspection to be performed at the facility, wherein each mobile collection device collects inspection data corresponding to the inspection to be performed at the facility and stores the inspection data in a remote database; and
receiving updated scheduling information based on the stored inspection data.

12. The method of claim 11, wherein sending scheduling information comprises sending a required completion date for the inspection to be performed at the facility.

13. The method of claim 11, wherein inspection data is collected from a plurality of inspectors using mobile data collection devices and combined onto a single mobile data collection device.

14. A method for performing a facility program evaluation, comprising:
sending, to at least one mobile data collection device, scheduling information corresponding to an program evaluation to be performed at a facility, the program evaluation being for use in rating safety and health guidelines at the facility;
transmitting, to each mobile collection device, periodic reminders of the program evaluation to be performed at the facility, wherein each mobile collection device collects program evaluation data corresponding to the program evaluation to be performed at the facility and stores the program evaluation data in a remote database; and
receiving updated scheduling information based on the stored program evaluation data.

15. The method of claim 14, wherein sending scheduling information comprises sending a required completion date for the program evaluation to be performed at the facility.

16. An apparatus for performing a facility inspection, comprising: means for receiving scheduling information corresponding to an inspection to be performed at a facility;
means for collecting inspection data corresponding to the inspection to be performed at the facility;
means for storing the inspection data in a database;
means for modifying the stored inspection data using a web interface; and
means for updating the scheduling information based on the stored inspection data.

17. The apparatus of claim 16, wherein the means for receiving scheduling information comprises means for receiving a required completion date for the inspection to be performed at the facility.

18. The apparatus of claim 16, the means for collecting comprising:
means for collecting data from a single inspector using a mobile data collection device.

19. The apparatus of claim 16, the means for collecting comprising:
means for collecting data from a plurality of inspectors using mobile data collection devices; and
means for combining the data from the plurality of inspectors onto a single mobile data collection device.

20. The apparatus of claim 16, further comprising:
means for receiving periodic reminders of the inspection to be completed at the facility.

21. The apparatus of claim 20, further comprising:
means for ceasing to receive the periodic reminders of the inspection to be completed at the facility, once the inspection data has been collected and stored.

22. An apparatus for performing a facility program evaluation, comprising:
means for receiving scheduling information corresponding to a program evaluation to be performed at a facility, the program evaluation being for use in rating safety and health guidelines at the facility;
means for collecting program evaluation data corresponding to the program evaluation to be performed at the facility;
means for calculating a score associated with the program evaluation;
means for storing the program evaluation data and calculated score in a database; and
means for updating the scheduling information based on the stored program evaluation data and calculated score.

23. The apparatus of claim 22, wherein the means for receiving scheduling information comprises means for receiving a required completion date for the program evaluation to be performed at the facility.

24. The apparatus of claim 22, further comprising:
means for receiving periodic reminders of the program evaluation to be completed at the facility.

25. The apparatus of claim 24, further comprising:
means for ceasing to receive the periodic reminders of the program evaluation to be completed at the facility, once the program evaluation data has been collected and stored.

26. An apparatus for performing a facility inspection, comprising:
means for sending, to at least one mobile data collection device, scheduling information corresponding to an inspection to be performed at a facility;
means for transmitting, to each mobile collection device, periodic reminders of the inspection to be performed at the facility, wherein each mobile collection device collects inspection data corresponding to the inspection to be performed at the facility and stores the inspection data in a remote database; and
means for receiving updated scheduling information based on the stored inspection data.

27. The apparatus of claim 26, wherein the means for sending scheduling information comprises means for sending a required completion date for the inspection to be performed at the facility.

28. The apparatus of claim 26, wherein inspection data is collected from a plurality of inspectors using mobile data collection devices and combined onto a single mobile data collection device.

29. An apparatus for performing a facility program evaluation, comprising:
means for sending, to at least one mobile data collection device, scheduling information corresponding to an program evaluation to be performed at a facility, the program evaluation being for use in rating safety and health guidelines at the facility;
means for transmitting, to each mobile collection device, periodic reminders of the program evaluation to be performed at the facility, wherein each mobile collection device collects program evaluation data corresponding to the program evaluation to be performed at the facility and stores the program evaluation data in a remote database; and
means for receiving updated scheduling information based on the stored program evaluation data.

30. The apparatus of claim 29, wherein the means for sending scheduling information comprises means for sending a required completion date for the program evaluation to be performed at the facility.

31. A computer-readable medium containing instructions for performing a method for performing a facility inspection, the method comprising:
receiving scheduling information corresponding to an inspection to be performed at a facility;
collecting inspection data corresponding to the inspection to be performed at the facility;
storing the inspection data in a database;
modifying the stored inspection data using a web interface; and
updating the scheduling information based on the stored inspection data.

32. The computer-readable medium of claim 30, wherein receiving scheduling information comprises receiving a required completion date for the inspection to be performed at the facility.

33. The computer-readable medium of claim 31, the collecting comprising:
collecting data from a single inspector using a mobile data collection device.

34. The computer-readable medium of claim 31, the collecting comprising:
collecting data from a plurality of inspectors using mobile data collection devices;
combining the data from the plurality of inspectors onto a single mobile data collection device.

35. The computer-readable medium of claim 31, the method further comprising:
receiving periodic reminders of the inspection to be completed at the facility.

36. The computer-readable medium of claim 35, the method further comprising:
ceasing to receive the periodic reminders of the inspection to be completed at the facility, once the inspection data has been collected and stored.

37. A computer-readable medium containing instructions for performing a method for performing a facility program evaluation, the method comprising:
receiving scheduling information corresponding to a program evaluation to be performed at a facility, the program evaluation being for use in rating safety and health guidelines at the facility;
collecting program evaluation data corresponding to the program evaluation to be performed at the facility;
calculating a score associated with the program evaluation;
storing the program evaluation data and calculated score in a database; and
updating the scheduling information based on the stored program evaluation data and calculated score.

38. The computer-readable medium of claim 37, wherein receiving scheduling information comprises receiving a required completion date for the program evaluation to be performed at the facility.

39. The computer-readable medium of claim 37, the method further comprising:
receiving periodic reminders of the program evaluation to be completed at the facility.

40. The computer-readable medium of claim 39, the method further comprising:
ceasing to receive the periodic reminders of the program evaluation to be completed at the facility, once the program evaluation data has been collected and stored.

41. A computer-readable medium containing instructions for performing a method for performing a facility inspection, the method comprising:
sending, to at least one mobile data collection device, scheduling information corresponding to an inspection to be performed at a facility;
transmitting, to each mobile collection device, periodic reminders of the inspection to be performed at the facility, wherein each mobile collection device collects inspection data corresponding to the inspection to be performed at the facility and stores the inspection data in a remote database; and
receiving updated scheduling information based on the stored inspection data.

42. The computer-readable medium of claim 41, wherein sending scheduling information comprises sending a required completion date for the inspection to be performed at the facility.

43. The computer-readable medium of claim 41, wherein inspection data is collected from a plurality of inspectors using mobile data collection devices and combined onto a single mobile data collection device.

44. A computer-readable medium containing instructions for performing a method for performing a facility program evaluation, the method comprising:
sending, to at least one mobile data collection device, scheduling information corresponding to an program evaluation to be performed at a facility, the program evaluation being for use in rating safety and health guidelines at the facility;
transmitting, to each mobile collection device, periodic reminders of the program evaluation to be performed at the facility, wherein each mobile collection device collects program evaluation data corresponding to the program evaluation to be performed at the facility and stores the program evaluation data in a remote database; and
receiving updated scheduling information based on the stored program evaluation data.

45. The computer-readable medium of claim 44, wherein sending scheduling information comprises sending a required completion date for the program evaluation to be performed at the facility.

46. An apparatus for performing a facility inspection, comprising:
a memory having a program that receives scheduling information corresponding to an inspection to be performed at a facility, collects inspection data corresponding to the inspection to be performed at the facility, stores the inspection data in a database, modifies the stored inspection data using a web interface, and updates the scheduling information based on the stored inspection data; and
a processor that runs the program.

47. The apparatus of claim 46, wherein the scheduling information comprises a required completion date for the inspection to be performed at the facility.

48. The apparatus of claim 46, wherein the program gathers data from a single inspector using a mobile data collection device.

49. The apparatus of claim 46, wherein the program gathers data from a plurality of inspectors using mobile data collection devices, and combines the data from the plurality of inspectors onto a single mobile data collection device.

50. The apparatus of claim 46, wherein the program receives periodic reminders of the inspection to be completed at the facility.

51. The apparatus of claim 50, wherein the program ceases to receive the periodic reminders of the inspection to be completed at the facility, once the inspection data has been collected and stored.

52. An apparatus for performing a facility program evaluation, comprising:
a memory having a program that: receives scheduling information corresponding to a program evaluation to be performed at a facility, the program evaluation being for use in rating safety and health guidelines at the facility; collects program evaluation data corresponding to the program evaluation to be performed at the facility; calculates a score associated with the program evaluation; stores the program evaluation data and calculated score in a database; and updates the scheduling information based on the stored program evaluation data and calculated score; and
a processor that runs the program.

53. The apparatus of claim 52, wherein the scheduling information comprises a required completion date for the program evaluation to be performed at the facility.

54. The apparatus of claim 52, wherein the program receives periodic reminders of the program evaluation to be completed at the facility.

55. The apparatus of claim 54, wherein the program ceases to receive the periodic reminders of the program evaluation to be completed at the facility, once the program evaluation data has been collected and stored.

56. An apparatus for performing a facility inspection, comprising:
a memory having a program that: sends, to at least one mobile data collection device, scheduling information corresponding to an inspection to be performed at a facility; transmits, to each mobile collection device, periodic reminders of the inspection to be performed at the facility, wherein each mobile collection device collects inspection data corresponding to the inspection to be performed at the facility and stores the inspection data in a remote database; and receives updated scheduling information based on the stored inspection data; and
a processor that runs the program.

57. The apparatus of claim 56, wherein the scheduling information comprises a required completion date for the inspection to be performed at the facility.

58. The apparatus of claim 56, wherein inspection data is collected from a plurality of inspectors using mobile data collection devices and combined onto a single mobile data collection device.

59. An apparatus for performing a facility program evaluation, comprising:
a memory having a program that: sends, to at least one mobile data collection device, scheduling information corresponding to an program evaluation to be performed at a facility, the program evaluation being for use in rating safety and health guidelines at the facility; transmits, to each mobile collection device, periodic reminders of the program evaluation to be performed at the facility, wherein each mobile collection device collects program evaluation data corresponding to the program evaluation to be performed at the facility and stores the program evaluation data in a remote database;
and receives updated scheduling information based on the stored program evaluation data; and
a processor that runs the program.

60. The apparatus of claim 59, wherein the scheduling information comprises a required completion date for the program evaluation to be performed at the facility.

61. A system for managing facility inspections, comprising:
a network;
a data center comprising a database;
a plurality of mobile data collection devices operable to receive scheduling information corresponding to an inspection to be performed at a facility, collect inspection data corresponding to the inspection to be performed at the facility, send the inspection data to the data center for storage in the database, modify the stored inspection data via the network using a web interface, and update the scheduling information based on the stored inspection data; and
a plurality of clients operable to send the scheduling information to the mobile data collection devices and receive updated scheduling information based on the stored inspection data.

62. A system for managing facility program evaluations, comprising:
a network;
a data center comprising a database;
a plurality of mobile data collection devices operable to receive scheduling information corresponding to a program evaluation to be performed at a facility, collect program evaluation data corresponding to the program evaluation to be performed at the facility, calculate a score associated with the program evaluation, send the program evaluation data to the data center for storage in the database, and update the scheduling information based on the stored program evaluation data and calculated
a plurality of clients operable to send the scheduling information to the mobile data collection devices and receive updated scheduling information based on the stored program evaluation data.
